(19) United States
(12) Patent Application Publication
(10) Pub. No.: US 2012/0117696 A1
(43) Pub. Date: May 10, 2012

(54) INTEGRATED METALLIC MICROTIP COUPON STRUCTURE FOR ATOM PROBE TOMOGRAPHIC ANALYSIS

(75) Inventors: Michael Hatzistergos, Beacon, NY (US); Christopher M. Molella, Poughkeepsie, NY (US); Paul Ronsheim, Hopewell Junction, NY (US); Matthew F. Stanton, Salt Point, NY (US)

(73) Assignee: INTERNATIONAL BUSINESS MACHINES CORPORATION, Armonk, NY (US)

(21) Appl. No.: 12/942,403

(22) Filed: Nov. 9, 2010

(51) Int. Cl. G01Q 70/00; G01Q 70/16

(52) U.S. Cl. 850/60; 850/52

(57) ABSTRACT

An integrated coupon structure for atom probe tomography (APT) analysis includes a base portion and an array of microtip posts protruding from the base portion. Both the base portion and the microtip posts formed from a same metal material, and the microtip posts being shaped at an apex thereof so as to be adapted to receive a sample attached thereto.

### BACKGROUND

The present invention relates generally to specimen analysis in semiconductor device manufacturing and, more particularly, to an integrated metallic microtip coupon structure for atom probe tomographic (APT) analysis.

An atom probe (also referred to as an atom probe microscope) is a device that allows specimens appropriately sized or taken from larger samples, such as semiconductor wafers or large parts thereof, to be analyzed on an atomic level. For example, a typical atom probe includes a specimen mount, an electrode, and a detector. During analysis, a specimen is carried by the specimen mount and a positive electrical charge (e.g., a baseline voltage) is applied to the specimen. The detector is spaced apart from the specimen and is negatively charged. The electrode is located between the specimen and the detector, and is either grounded or negatively charged. A positive electrical pulse (above the baseline voltage) and/or a laser pulse (e.g., photonic energy) is intermittently applied to the specimen. Alternately, a negative pulse can be applied to the electrode.

With each pulse, one or more atoms on the specimen surface are ionized. As shown in FIG. 1, a needle shaped specimen 100 has an apex 102 having a tip radius on the order of about 50 nanometers (nm). Each ionized atom separates or “evaporates” from the surface, passes though an aperture in the electrode (not shown), and impacts the surface of the detector 104. The identity of an ionized atom can be determined by measuring its time of flight between the surface of the specimen and the detector, which varies based on the mass/charge ratio of the ionized atom. Thus, identity of a first atom 106 is distinguishable from the identity of a second atom 108. Also, the location of the ionized atom on the surface of the specimen can also be determined by measuring the location of the atom's impact on the detector 102. Accordingly, as the specimen is evaporated, a three-dimensional map 110 of the specimen's constituents can be constructed.

Specimens are often formed by removing a section or wedge from the sample that represents the structure of the sample throughout at least a portion of its depth. Such a specimen is typically attached to a pre-made post and then sharpened by ion milling. The specimen-post combination is then aligned in a specimen holder with its axis extending toward the detector, so that the collected atoms demonstrate the depthwise structure of the sampled object. The rod-like structure of the prepared specimen also beneficially concentrates the electric field of the charged specimen about its apex (its area closest to the detector), thereby enhancing evaporation from the apex.

In order to increase the throughput of APT analysis, the posts to which specimens are mounted have been manufactured as prefabricated arrays of posts. For example, a 6×6 microtip array may be formed into a small coupon of about 3 millimeters (mm)×7 mm in area. The coupon is then attached to a metal carrier that is then loaded into the atom probe. Thus, such coupons having an array of individual microtips reduces sample transfer overhead with respect to single post structures.

However, these coupons are typically made out of silicon (Si), and doped with antimony (Sb) or arsenic (As) to improve conductivity of the posts. Unfortunately, even with the doping, silicon or other semiconductor materials do not provide the optimal electrical and thermal conduction characteristics desirable for preventing sample fracturing and data quality degradation.

### SUMMARY

In one aspect, an integrated coupon structure for atom probe tomography (APT) analysis includes a base portion; an array of microtip posts protruding from the base portion, with both the base portion and the microtip posts formed from a same metal material; and the microtip posts being shaped at an apex thereof so as to be adapted to receive a sample attached thereto.

In another aspect, a method of forming an integrated coupon structure for atom probe tomography (APT) analysis includes thinning a metal material base portion having an original thickness so as to define an array of microtip posts protruding from the base portion; and shaping the microtip posts so as to be adapted to receive a sample attached at an apex of the posts.

In another aspect, a method of performing for atom probe tomography (APT) analysis includes attaching one or more samples to an integrated coupon structure, the coupon structure comprising a base portion, an array of microtip posts protruding from the base portion, with both the base portion and the microtip posts formed from a same metal material, and the microtip posts being shaped at an apex thereof so as to be adapted to receive a sample attached thereto; mounting the integrated coupon structure to a sample holder housed within a chamber of an atom probe; and operating the atom probe so as to cause evaporation of individual atoms at a tip of the sample.

### BRIEF DESCRIPTION OF THE SEVERAL VIEWS OF THE DRAWINGS

Referring to the exemplary drawings wherein like elements are numbered alike in the several Figures:

FIG. 1 is a schematic diagram illustrating the principles of APT analysis;

FIG. 2 is a schematic block diagram of an exemplary atom probe system suitable for use in accordance with an embodiment of the invention;

FIG. 3(a) is an image of a conventional silicon microtip array coupon having individual posts to which APT samples are mounted;

FIG. 3(b) is a more detailed image of one of the posts of the coupon of FIG. 3(a);

FIG. 3(c) is a more detailed image of the topmost portion of the post of FIG. 3(b), on which an APT sample is mounted thereto;

FIG. 3(d) is an image illustrating an intermediate stage of sharpening of the post tip and sample of FIG. 3(c);

FIG. 3(e) illustrates the test-ready sharpened post tip and sample of FIGS. 3(c) and 3(d); and

FIG. 3(f) is an even further detailed image of the sharpened sample of FIG. 3(d), including an insert highlighting a region of interest at the apex of the sharpened sample;

FIG. 4 is a side view of a conventional silicon microtip array coupon attached to a metal carrier;

FIG. 5 is a side view of an integrated metallic microtip coupon structure, in accordance with an embodiment of the invention; and

FIG. 6 is a perspective view of an integrated metallic microtip coupon structure, in accordance with an embodiment of the invention.

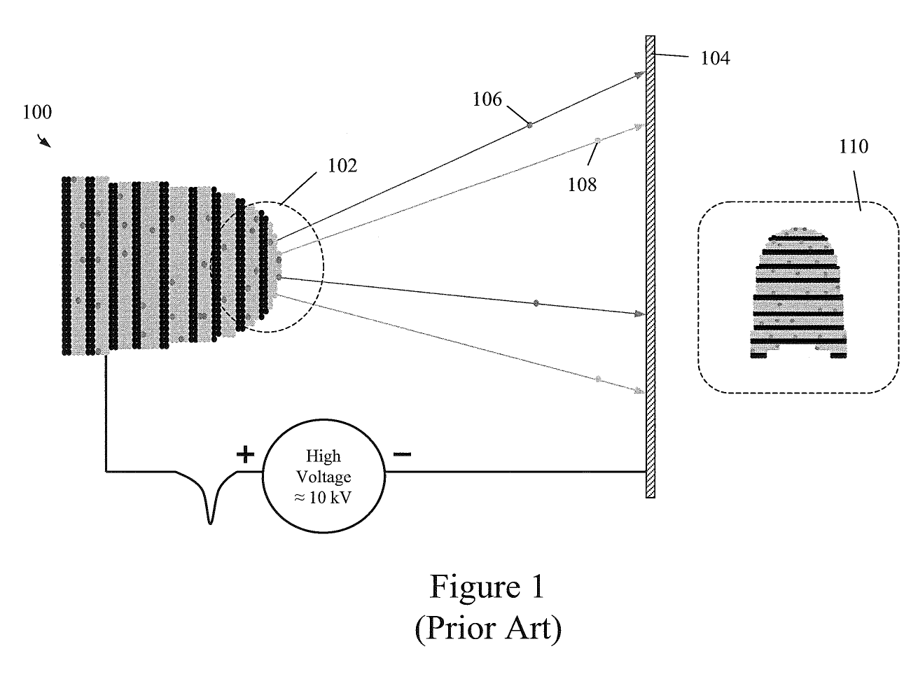

### DETAILED DESCRIPTION

Disclosed herein is an integrated metallic microtip coupon structure for APT analysis. As indicated above, APT requires the placement of the sample to be analyzed on a conductive post. Conventional silicon or doped silicon posts provide limited electrical and thermal conductivity. Therefore, by integrating a coupon into a metal holder to create a single, electrically and thermally conductive solid structure for insertion into an atom probe, a more effective sample preparation path is achieved. This in turn enhances sample preparation and the operation of imaging and analytical techniques such as, for example, APT, transmission electron microscopy (TEM), scanning electron microscopy (SEM), focused ion beam (FIB), and scanning probe microscopy (SPM).

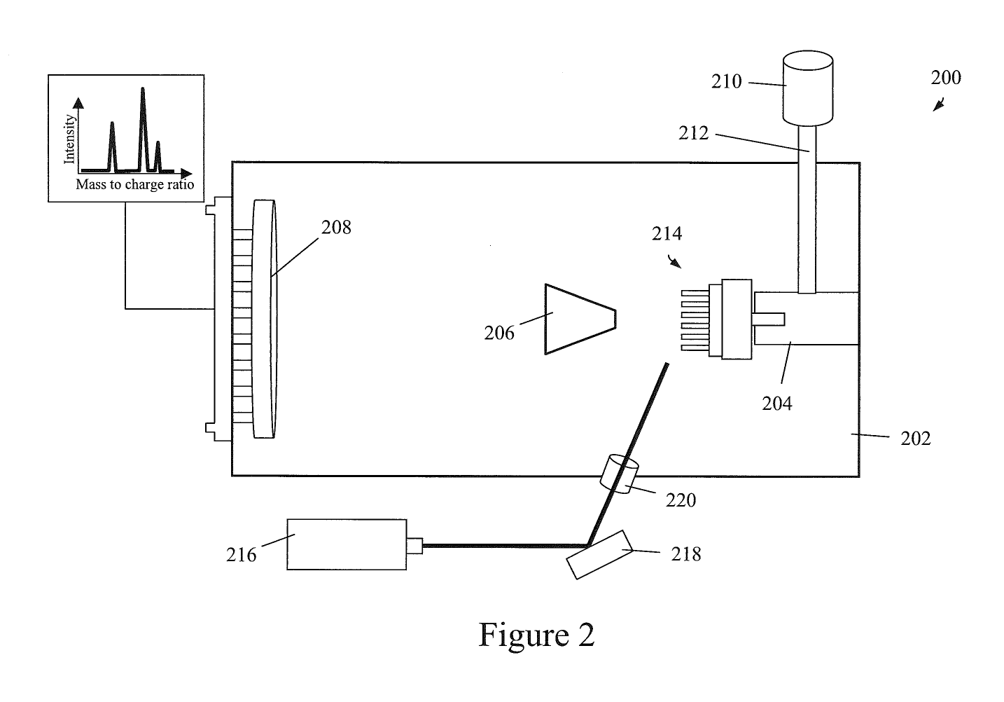

Referring now to FIG. 2, there is shown a schematic block diagram of an exemplary atom probe system 200 suitable for use in accordance with an embodiment of the invention. The atom probe system 200 includes a chamber 202 that houses a sample holder 204, aperture 206 and detector 208. A cryostat 210 is used to cool the sample holder 204 via one or more passageways 212. The cryostat uses helium to achieve the low temperatures, in combination with metal foils (such as copper for its good thermal properties) attached to the stage. Heat travels through the wire strands/metal foils. The sample holder 204 in turn cools a sample microtip array structure 214, on which one or more samples are mounted. In addition, for photon-assisted APT, a laser source 216 provides a pulsed input beam directed through one or more optical devices such as a mirror 218 and focusing lens 220 so as to trigger evaporation of the atoms at the tip of the sample surface. The evaporated atoms pass through the aperture 206 and strike the detector 208, yielding a reconstructive map of the sample's constituent atomic structure.

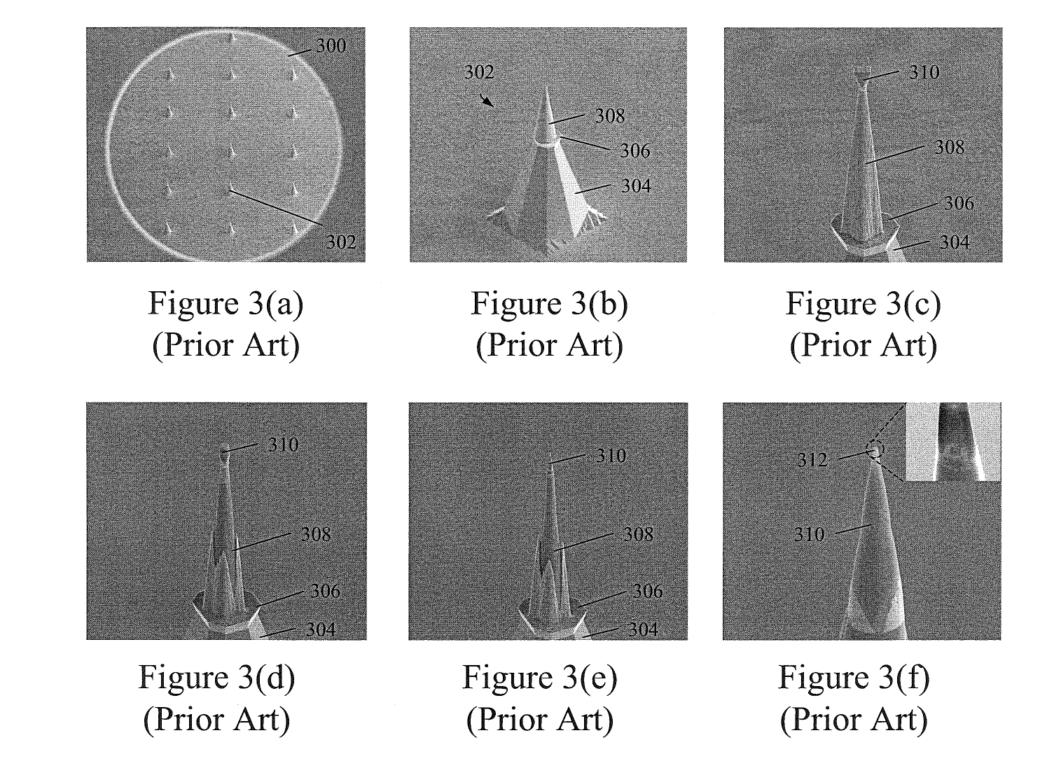

FIG. 3(a) is an image of a conventional silicon microtip array coupon 300 having a plurality of individual posts 302 defined thereon, such as by etching into a silicon substrate. As shown more particularly in FIG. 3(b), each of the microtip array posts has a relatively wide base portion 304, the faceting of which due to the crystalline and etch properties of silicon is observable, a flat portion 306 atop the base portion 304, and a slender, cone shaped top portion 308 atop the flat portion. As manufactured, the apex of the top portion 308 of the post 302 may be on the order of about 2 microns (μm) in thickness.

FIG. 3(c) is a more detailed image of the top portion 308 of the post 302 of FIG. 3(b), and further illustrates an APT sample 310 mounted thereto. The attachment may be accomplished by welding the specimen on the post using an FIB assisted localized vapor deposition, or could also be facilitated by any suitable technique in the art for affixing nanoscale objects such as, for example, adhesives, electron beam deposition, and laser or thermal soldering. Once the sample 310 is mounted to the post, a sharpening process is used to prepare the sample for APT analysis. An intermediate stage of the sharpening of the top portion of the post 302 and sample 310 is shown FIG. 3(d).

In FIG. 3(e), the sharpening process is completed, rendering the sample 310 ready for APT analysis, wherein the tip radius of the sample is reduced to the order of about 50 nm. FIG. 3(f) is an even further detailed image of the sharpened sample 310 of FIG. 3(d), including an insert highlighting a region of interest 312 at the apex of the sharpened sample 310.

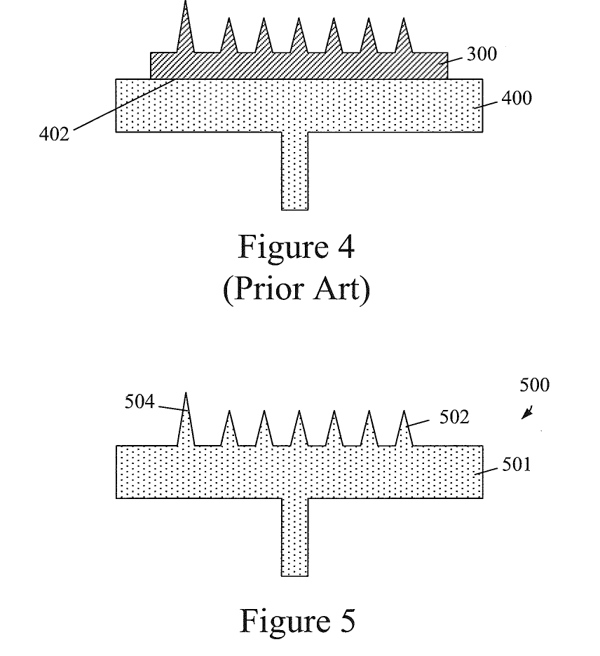

As further indicated above, a conventional silicon microtip array coupon, such as the coupon 300 in FIG. 3(a), is attached to a metal carrier 400 that is then loaded into the atom probe, as shown in the side view of FIG. 4. In addition to the lower thermal and electrical conductivity of a silicon coupon in comparison to the metal carrier, there is also an interface 402 between the two materials due to the mechanical bonding (e.g., epoxy) of the coupon 300 to the carrier 400.

Accordingly, FIG. 5 is a side view of an integrated metallic microtip coupon structure 500, in accordance with an embodiment of the invention. Rather than two separate components, the structure 500 provides both a holder (base) portion 501 and an array of microtips 502 with a single metal material. In one exemplary embodiment, the metal material is copper (Cu), having an electrical conductivity of about 5.8×10⁶ siemens per meter (S/m) as compared to about 1.2×103 S/m for Si, representing over a 1000× increase in electrical conductivity. In addition, Cu has a thermal conductivity of about 400 watts per meter Kelvin (W/mK) as compared to about 150 w/mK for Si, represent about a 2-3× increase in thermal conductivity. It is contemplated that, in addition to Cu or alloys thereof, other materials, such as aluminum (Al), tungsten (W), brass, etc., may also be used.

The metallic microtip coupon structure 500 of the present embodiment may be formed by micromachining a starting metal block having an initial thickness, selectively removing areas not corresponding to the post regions until a desired shape, height and number of posts 502 are obtained. As is the case with a silicon coupon, the integrated metallic microtip coupon structure 500 may include one or more marker posts 504 that are formed at a greater height than the microtip posts. Thus, when the coupon structure 500 is mounted the APT, the posts may be counted, starting from the marker post(s) 504 until the specific post 502 carrying the specimen to be analyzed is found.

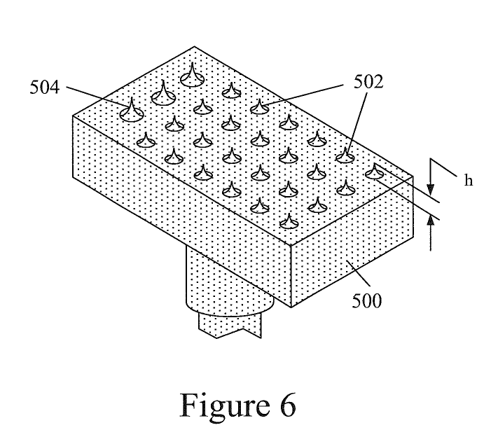

FIG. 6 is a perspective view of the integrated metallic microtip coupon structure 500 of FIG. 5. In the exemplary embodiment shown, the posts 502 are machined to a height, h, of about 1/100^{th} of an inch (254 μm) and are spaced apart from adjacent posts 502 by about a distance of about 0.042 inches (1067 μm). The posts 502 also have a machined tip width of about 10 μm in the illustrated embodiment. Other dimensions, however, are also contemplated. For example, it is contemplated that with ion milling or lithographic techniques, the tip width may be reduced even further, on the order of about 2 μm or less.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An integrated coupon structure for atom probe tomography (APT) analysis, comprising:
a base portion;
an array of microtip posts protruding from the base portion, with both the base portion and the microtip posts formed from a same metal material; and
the microtip posts being shaped at an apex thereof so as to be adapted to receive a sample attached thereto.

2. The structure of claim 1, wherein the base portion and the microtip posts are formed from a copper containing material.

3. The structure of claim 1, wherein the microtip posts are formed to a height of about 250 microns (μm).

4. The structure of claim 3, wherein the microtip posts have a tip width of about 10 μm or less.

5. The structure of claim 4, wherein adjacent microtip posts are spaced apart from one another by about a distance of about 1000 μm.

6. The structure of claim 1, wherein the base portion and the microtip posts have an electrical conductivity of about 1×10⁶ siemens per meter (S/m) or greater.

7. The structure of claim 1, wherein the base portion and the microtip posts have a thermal conductivity of about 400 watts per meter Kelvin (W/mK) or greater.

8. The structure of claim 1, further comprising one or more marker posts protruding from the base portion, the one or more marker posts also formed from the same metal material as the base portion and the microtip posts.

9. A method of forming an integrated coupon structure for atom probe tomography (APT) analysis, the method comprising:
thinning a metal material base portion having an original thickness so as to define an array of microtip posts protruding from the base portion; and
shaping the microtip posts so as to be adapted to receive a sample attached at an apex of the posts.

10. The method of claim 9, further comprising forming the base portion and the microtip posts from a copper containing material.

11. The method of claim 9, further comprising forming the microtip posts to a height of about 250 microns (μm).

12. The method of claim 11, further comprising forming the microtip posts to have a tip width of about 10 μm or less.

13. The method of claim 12, wherein adjacent microtip posts are spaced apart from one another by about a distance of about 1000 μm.

14. The method of claim 9, wherein the base portion and the microtip posts have an electrical conductivity of about 1×10⁶ siemens per meter (S/m) or greater.

15. The method of claim 9, wherein the base portion and the microtip posts have a thermal conductivity of about 400 watts per meter Kelvin (W/mK) or greater.

16. The method of claim 9, further comprising forming one or more marker posts protruding from the base portion, the one or more marker posts also formed from the same metal material as the base portion and the microtip posts.

17. A method of performing for atom probe tomography (APT) analysis, the method comprising:
attaching one or more samples to an integrated coupon structure, the coupon structure comprising a base portion, an array of microtip posts protruding from the base portion, with both the base portion and the microtip posts formed from a same metal material, and the microtip posts being shaped at an apex thereof so as to be adapted to receive a sample attached thereto;
mounting the integrated coupon structure to a sample holder housed within a chamber of an atom probe; and
operating the atom probe so as to cause evaporation of individual atoms at a tip of the sample.

18. The method of claim 17, wherein the base portion and the microtip posts are formed from a copper containing material.

19. The method of claim 17, wherein the microtip posts are formed to a height of about 250 microns (μm).

20. The method of claim 19, wherein the microtip posts have a tip width of about 10 μm or less.

21. The method of claim 20, wherein adjacent microtip posts are spaced apart from one another by about a distance of about 1000 μm.

22. The method of claim 17, wherein the base portion and the microtip posts have an electrical conductivity of about 1×10⁶ siemens per meter (S/m) or greater.

23. The method of claim 17, wherein the base portion and the microtip posts have a thermal conductivity of about 400 watts per meter Kelvin (W/mK) or greater.

24. The method of claim 17, wherein the integrated coupon structure further comprises one or more marker posts protruding from the base portion, the one or more marker posts also formed from the same metal material as the base portion and the microtip posts.
